(19) United States
(12) Patent Application Publication
(10) Pub. No.: US 2016/0159067 A1
(43) Pub. Date: Jun. 9, 2016

(54) POLYMER COMPOSITE COATINGS USING FIBRILLATED PTFE PREFORMS

(71) Applicant: Michael A. Speckert, Kingwood, TX (US)

(72) Inventor: Michael A. Speckert, Kingwood, TX (US)

(21) Appl. No.: 14/961,286

(22) Filed: Dec. 7, 2015

Related U.S. Application Data
(60) Provisional application No. 62/088,682, filed on Dec. 7, 2014.

(51) Int. Cl. B32B 38/08; B32B 5/02; B32B 7/12; B29C 65/00; B32B 15/08; B32B 37/06; B32B 38/18; B29C 65/48; B05D 7/02; B32B 37/12

(52) U.S. Cl. CPC B32B 38/08; B05D 7/02; B32B 5/022; B32B 7/12; B32B 37/1284; B32B 15/08; B32B 37/06; B32B 38/1866; B29C 65/483; B29C 66/0012; B29C 66/712; B29C 66/72941; B29C 66/742; B32B 2260/046; B32B 2260/021; B32B 2262/02; B32B 2305/72; B32B 2327/18; B29K 2627/18

(57) ABSTRACT

A method for deploying an epoxy-based coating on a surface of an article, the method comprising the steps of: (a) providing an article including a metallic surface to be coated, the metallic surface presenting itself as a substrate; (b) preparing a self-sustaining, cloth-like, flexible, non-woven fibrillated PTFE preform with voids therein; (c) conforming the preform to the metallic surface; (d) infiltrating at least some of the voids with an epoxy in an uncured state; and (e) curing the epoxy; whereby an epoxy-based coating is formed on the metallic surface. In some embodiments, the PTFE preform in step (b) is a composite fibrillated PTFE preform comprising PTFE mixed with hard particles. Articles of manufacture are also disclosed having an epoxy-based coating deployed according to the embodiments of the disclosed coating methods.

### PRIORITY CLAIM AND INCORPORATION BY REFERENCE

This non-provisional application claims priority to, and the benefit of, commonly-invented U.S. provisional patent application “POLYMER COMPOSITE COATINGS USING FIBRILLATED PTFE PREFORMS”, Ser. No. 62/088,682, filed Dec. 7, 2014. This non-provisional application further incorporates the entire disclosure of Ser. No. 62/088,682 by reference.

### FIELD OF THE DISCLOSURE

This disclosure is directed generally to methods for deploying coatings on products, and more specifically to methods deploying such coatings using fibrillated polytetrafluoroethylene (“PTFE”) preforms. This disclosure is further directed to articles of manufacture and items of equipment that facilitate the disclosed coating methods.

### BACKGROUND

Numerous conventional techniques are known in the prior art to combat wear and corrosion generally, and particularly on metal components, and usually involve the application of sacrificial materials over the surfaces that require protection. Some of the more common methods include weld overlay, thermal spray and plating. While their widespread use across many industries are evidence of their success in wear protection, these processes have limitations that preclude them from being utilized in some applications. For instance, the high temperatures associated with welding limit their use to applications where temperature would not adversely affect the component materially or dimensionally. Likewise, thermal spray also has temperature-impact limitations, as well as the inability to be applied in non line-of-sight locations. In some cases, accessibility or the necessity to conduct field repairs (while in service) also preclude these processes from being used.

Epoxy resins are a class of cross-linking polymers that have a wide range of chemical and mechanical properties, including high adhesion strength, excellent chemical and heat resistance and good-to-excellent mechanical strength. Applications for epoxy based materials are extensive and include coatings (wear resistant coatings, floor coatings, water-repellant wood treatments, anti-corrosive coatings), adhesives and composite materials. Epoxies can be engineered to achieve a wide range of chemical and mechanical properties by modifying the underlying chemistry of the compounds and through the addition of fillers such as hard oxides (i.e. aluminum oxide), carbides (i.e. silicon carbide, tungsten carbide) and metals (steel and stainless steel). The foregoing characteristics of epoxy resins, in combination with the limitations of some of the before-mentioned processes, have led to the wide use of epoxy resins in applications where mechanical wear, corrosion or a combination thereof has limited the functionality and life of a component.

The conventional application of epoxy wear coatings starts with the mixing process where a resin and a hardener are mixed together. In many applications, the mix may be in equal proportions, although this is not universal. Other materials, such as ceramics, metals or carbide pellets, powders or chips are often added to the mix to increase hardness and improve wear resistance. Depending on the chemistry system, the working time of the epoxy system can vary from just a few minutes to hours. Some epoxy systems will cure (harden) at room temperature, while others may require heat to cure. After mixing, application of the epoxy material is typically accomplished by hand using trowels, brushes and rollers. In some cases, specialized high-pressure spray systems can be used to apply the materials over large surface areas.

While epoxy systems have proven to be a reliable, cost-effective way of combating wear and corrosion, these systems also have their limitations and drawbacks. As noted above, in applications of high wear, epoxy-based coatings are often enhanced by adding hard-particle fillers such as ceramics or carbides to increase hardness and improve wear resistance. Unfortunately, the physical limitations of most epoxy systems limit the amount of hard particle content that can be added to about 50% hard particle content. In many applications, enhanced epoxy systems with only 50% hard particle content do not offer the necessary wear resistance required for the application. Furthermore, the particle size of these admixed materials is often selected to be quite large in order to facilitate mixing, and to increase the amount of hard particle material that is effectively exposed to receive wear in the wear surface. This selection of particle size, plus the fact that these systems are often applied by hand (where thickness control and applications accuracy are limited), result in a product whose appearance is often unappealing due to a grainy, irregular surface finish of the final product.

For example, FIG. 1 in U.S. Provisional Patent Application Ser. No. 62/088,682, whose provisional disclosure is incorporated herein by reference and to which this nonprovisional application claims priority, depicts photographs of epoxy resins being applied by hand to the inside of various pump casings according to conventional techniques. It will be appreciated from review of these photographs that tangible difficulties arise in maintaining consistent thickness control, applications accuracy and appealing final appearance when epoxy-based coatings are applied by hand.

The epoxy-based coatings disclosed in this application address the foregoing limitations in current conventional epoxy wear coating technology through the application of such epoxy-based coatings in conjunction with fibrillated PTFE preforms. The general use of fibrillated PTFE preforms to assist the deployment of uniform, high performance wear coatings is well established in the art. For example, U.S. Pat. No. 3,864,124 to Breton et al. (hereafter, “Breton”) discloses a sintering process in which wear coating particles are first mixed with fibrillated PTFE into a composite preform. The preform presents itself like a cloth, and may be conformed to a surface to be coated. The surface to be coated thereby acts as a substrate. Once the preform is deployed on the substrate, heat is applied sufficient to fuse or sinter the wear particles to the substrate.

Although Breton illustrates the advantageous use of fibrillated PTFE preforms in a general sense, the epoxy-based coatings technology disclosed in this application are distinguishable in that Breton teaches heat treatment sufficient to sinter or fuse the wear particles to the substrate. The epoxy-based coatings technology disclosed in this application obviates this step.

Other patents disclose improvements on the general use of fibrillated PTFE preforms to assist the deployments of uniform, high performance wear coatings in particle form. For example, U.S. Pat. No. 4,624,860 to Alber et al. (hereafter, “Alber”) discloses a coating process generally in accordance with Breton, except that the application of heat is selectively controlled during the final phase. Alber discloses use of a localized heat source, such as a coil and frequency induction generator, to apply suitable heat to the deployed preform in selectively controlled locations only. This is in distinction to Breton, which discloses generally heating the entire article to be coated in a furnace or autoclave, for example, after preform deployment. Again, although Alber illustrates generally the advantageous use of selectively controlled heat sources to apply heat to deployed PTFE preforms, the epoxy-based coatings technology disclosed in this application distinguish over Alber for the same reason as for Breton, as described above.

Epoxy-based materials have been used in the past in conjunction with fibrillated PTFE preforms. In such prior art coatings, metallic particle coatings (such as disclosed in Breton and Alber) are deployed on an injection-molded component made from a reinforced epoxy material. For example, U.S. Pat. No. 4,923,737 to De La Torre discloses manufacture of an injection-molded reinforced epoxy component with a metallic particle wear coating. Fibrillated PTFE is mixed with metallic particles to form a composite preform, which in turn is deployed on the surface of a tool or die from which an injection-molded epoxy component is to be formed. In most examples disclosed in De La Torre, a layer of thermosetting epoxy “prepreg” reinforced with glass or graphite fiber, for example, is deployed on top the preform to form a laminate. A desired epoxy article of manufacture is then injection molded on top of the epoxy prepreg side of the laminate at elevated temperature and pressure, so that the injection molding process forms an epoxy article of manufacture with a hard particle coating. In Example IV in De La Tone, the reinforced prepreg layer is omitted. Non-metallic particles are substituted for metallic particles in the PTFE preform, and unreinforced epoxy resin is injection molded directly onto the PTFE/non-metallic particle preform. In all examples, epoxy either in the prepreg layer or in the injection mold itself is forced into the remaining open interstices in the fibrillated PTFE perform (i.e. those interstices not occupied by hard particles mixed with PTFE in the preform).

Although De La Torre illustrates the advantageous use of epoxy in wear coatings, the epoxy-based coatings technology disclosed in this application is distinguishable in that De La Torre teaches wear coatings that are deployed exclusively on injection-molded reinforced epoxy components. In De La Tone's disclosure, the epoxy material is the coated component and not part of the coating. More specifically, in most examples in De La Tone, the injection-molded reinforced epoxy component provides the substrate, a non-metallic substrate, onto which a separate metallic particle wear coating is applied. In Example IV, the injection-molded epoxy resin component provides the substrate, a non-metallic substrate, onto which a separate non-metallic particle wear coating is applied. By contrast to all examples disclosed in De La Torre, the epoxy-based coatings disclosed in this application are epoxy-based wear coatings deployed on separate metallic substrates. The epoxy-based coatings disclosed in this application are thus structurally distinguishable from De La Tone's disclosure. The epoxy-based coatings disclosed in this application further obviate reliance on injection molding (such as disclosed in De La Torre) or other manufacturing techniques that might enable the epoxy material to be the substrate and not part of the wear coating. Equally, because the epoxy-based coatings disclosed in this application are wear coatings and not the substrate, they may be deployed on any metallic substrate.

### SUMMARY OF DISCLOSED TECHNOLOGY AND TECHNICAL ADVANTAGES

The processes and related articles of manufacture and equipment described in this disclosure address the problems set forth in the “Background” section above, and other problems in the prior art.

Generally, the epoxy-based coatings disclosed in this applications include methods of forming a highly-dense polymer composite coating whose composition consists of a fibrillated PTFE preform in cloth form. The epoxy-based coatings are deployed on metallic substrate surfaces of an article to be coated. In embodiments in which the epoxy-based coatings include hard particles to increase the wear capability of the coating, the preform may be a composite of fibrillated PTFE mixed with metal oxide or metal carbide (such as aluminum oxide, silicon carbide, tungsten carbide and the like), although this disclosure is not limited in this regard. In currently preferred embodiments, the preform may be manufactured using the details as generally described in the Breton and Alber patents, identified above, although again this disclosure is not limited in this regard. Once deployed on the surface of an article to be coated, voids in the preform are then infiltrated by an epoxy. In embodiments in which the epoxy-based coatings include hard particles, the epoxy infiltrates into open voids in the preform that are not occupied by hard particles. In other embodiments without hard particles included in the preform, the epoxy simply infiltrates into open voids in the preform. The epoxy is then cured according to conventional techniques once it has infiltrated into the preform.

According to one aspect, this disclosure describes a method for deploying an epoxy-based coating on a surface of an article, the method comprising the steps of: (a) providing an article including a metallic surface to be coated, the metallic surface presenting itself as a substrate; (b) preparing a self-sustaining, cloth-like, flexible, non-woven fibrillated PTFE preform with voids therein; (c) conforming the preform to the metallic surface; (d) infiltrating at least some of the voids with an epoxy in an uncured state; and (e) curing the epoxy; whereby an epoxy-based coating is formed on the metallic surface. In some embodiments, the PTFE preform in step (b) is a composite fibrillated PTFE preform comprising PTFE mixed with hard particles. In some embodiments, infiltration in step (d) comprises saturation of the preform with epoxy prior to conforming the preform to the metallic surface in step (c). In some embodiments, the hard particles are selected from the group consisting of (1) metal oxide particles and (2) metal carbide particles. In some embodiments, infiltration in step (d) is encouraged by at least one technique selected from the group consisting of: (1) elevated epoxy pressure; (2) elevated gas pressure; and (3) vacuum pressure.

In other embodiments, step (d) comprises the substeps of: (d1) conforming a solid epoxy layer on the preform such that the preform separates the solid epoxy layer and the metallic surface; (d2) softening the solid epoxy layer via temperature elevation; and (d3) promoting infiltration of softened epoxy in substep (d2) into voids in the preform. In some embodiments, substep (d3) is accomplished using a technique selected from the group consisting of: (1) elevated epoxy pressure; (2) elevated gas pressure; (3) vacuum pressure; and (4) natural capillary action. In some embodiments, the solid epoxy layer in substep (d1) comprises a fibrillated PTFE preform mixed with solid epoxy particles.

According to a second aspect, this disclosure describes articles of manufacture having an epoxy-based coating deployed according to the embodiments of the methods also disclosed.

It will be appreciated that the epoxy-infiltrated PTFE preforms included in the disclosed epoxy-based coatings will provide a very dense coating system including cured epoxy, PTFE, and hard particles (in those embodiments in which the PTFE preform is a composite of PTFE and hard particles). It is therefore a technical advantage of the disclosed technology to offer improved wear resistance (i.e. life) over existing technologies/processes because of this very dense coating system. Further, the scope of this disclosure is not limited to deployment of just one PTFE preform layer. In embodiments including multiple layers, discrete layers of PTFE preforms with differing chemistries, microstructures, thicknesses and densities will combine to offer unique performance properties not available with other processes.

Another technical advantage is improved cost efficiency on larger jobs. On small surface areas, job costs will be higher as compared to other processes when considering the cost to manufacture the PTFE preforms. However, as the surface area to be coated (i.e. job size) increases, the ability to apply large sheets of epoxy-based coating systems over large surface areas in a short period of time will make it a more economical choice for wear protection. Further, the PTFE preforms are reliably uniform in thickness. Thus, the amount of material removal necessary on jobs calling for tight dimensional tolerances on surface finishes will be much less as compared to the uneven finishes produced with other conventional methods. Lower material removal means lower finishing costs.

A further technical advantage is improved aesthetics. Since the PTFE preforms are manufactured in such a way that produces a very smooth, even-textured and thickness cloth, the finish on the disclosed epoxy-based coating system will be much more appealing than conventional systems whose finished surfaces tend to be bumpy and uneven.

A further technical advantage is potentially improved coefficient of friction of the finished epoxy-based wear coating. In some applications for epoxy-based wear coatings consistent with this disclosure, such as (purely by way of example) on rotors for downhole positive displacement motors, the PTFE content of the wear coating will enable an advantageously lower coefficient of friction when operatively contacted by other surfaces. In the exemplary application of rotor coatings, the rotor contacts the stator in service. The lower coefficient of friction on the rotor coating will lower wear and heat generation as the rotor and stator make operative contact.

The foregoing has outlined rather broadly some of the features and technical advantages of the disclosed technology, in order that the detailed description that follows may be better understood. Additional features and advantages of the disclosed technology may be described. It should be appreciated by those skilled in the art that the conception and the specific embodiments disclosed may be readily utilized as a basis for modifying or designing other structures for carrying out the same inventive purposes of the disclosed technology, and that these equivalent constructions do not depart from the spirit and scope of the technology as described and as set forth in the appended claims.

### BRIEF DESCRIPTION OF THE DRAWINGS

For a more complete understanding of the embodiments described in this disclosure, and their advantages, reference is made to the following detailed description taken in conjunction with the accompanying drawings, in which:

FIGS. 1 through 5 illustrate alternative embodiments of methods, consistent with the scope of this disclosure, in which epoxy-based wear coatings are deployed on metallic substrate surfaces of articles of manufacture through use of fibrillated PTFE preforms.

### DETAILED DESCRIPTION

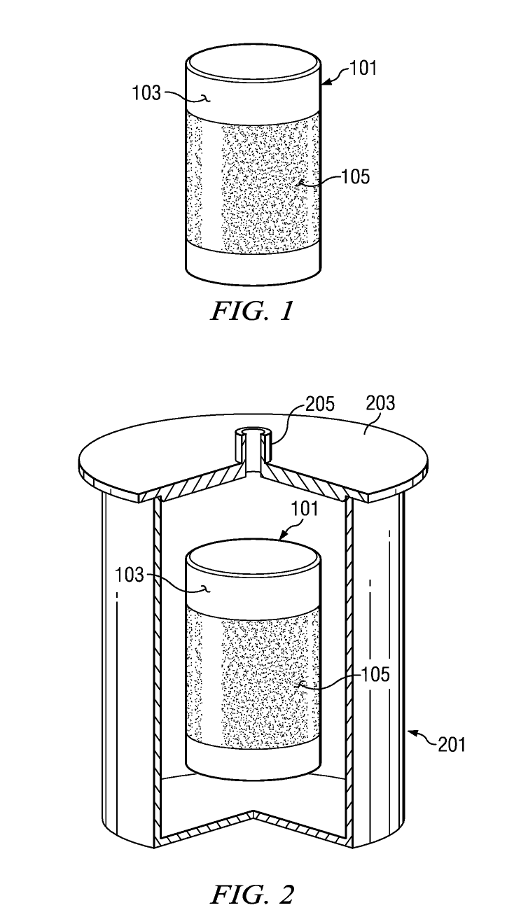

FIGS. 1 through 5 may be viewed together to assist further understanding of the immediately following disclosure. Any part, item, or feature that is identified by part number on one of FIGS. 1 through 5 has the same part number when further illustrated on another of FIGS. 1 through 5.

As noted above FIGS. 1 through 5 illustrate alternative embodiments of methods, consistent with the scope of this disclosure, in which epoxy-based wear coatings are deployed on metallic substrate surfaces of articles of manufacture through use of fibrillated PTFE preforms. FIG. 1 illustrates both a first and second embodiment in which component 101 is a cylindrically-shaped article of manufacture over which a portion of its exterior metallic substrate surface 103 is to receive an epoxy-based wear coating. Component 101 could be, just for example, a roller bearing. Fibrillated PTFE preform 105 has previously been prepared using the details as generally described in Breton and Alber, U.S. Pat. Nos. 3,864,124 and 4,624,860 as identified above. In a first embodiment, PTFE preform 105 is a composite in which PTFE has previously been mixed with hard particles. The hard particle material used is preferably a conventional aluminum oxide powder available from numerous suppliers, such as AGSCO, although the scope of the first embodiment is not limited to the type of hard particle used. In a second embodiment, PTFE preform 105 contains no hard particles previously mixed with the PTFE.

After preparation according to either first or second embodiments, but prior to deployment on metallic substrate surface 103 on FIG. 1, PTFE preform 105 is saturated in epoxy, preferably a conventional low-viscosity epoxy adhesive such as Loctite 3140, for example. It will be appreciated that the scope of this disclosure is not limited to type of epoxy selected, and other suitable epoxies are available. The epoxy relies upon natural capillary forces in the first and second embodiments to infiltrate PTFE preform 105. Upon saturation with epoxy, PTFE preform 105 is conformed to metallic substrate surface 103 in a desired configuration and positioned for final curing of the epoxy. The cured epoxy adheres the epoxy-based coating system to metallic substrate surface 103 (whether also including hard particles according to the first embodiment, or without hard particles according to the second embodiment). After curing, and if desired, the now hardened composite coating can be finished using conventional machining, grinding or polishing techniques to obtain a desired final finish and dimensional tolerances.

FIG. 2 illustrates a third embodiment of epoxy-based wear coatings consistent with the scope of this disclosure. Beyond relying on natural capillary forces to infiltrate epoxy into PTFE preform 105, such as described above with reference to FIG. 1, one could use other techniques to encourage such infiltration. FIG. 2 illustrates a third embodiment similar to the first and second embodiments illustrated on FIG. 1. In FIG. 2, PTFE preform 105 has been conformed to metallic substrate surface 103 and attached using the same epoxy that will be used to infiltrate PTFE preform 105. Alternatively, other conventional types of temporary attachment may be used to attach PTFE preform 105 to metallic substrate surface 103, such as mechanical attachments or other adhesives that are complimentary to and non-harmful to the epoxy being used to infiltrate the PTFE preform 105. Component 101 is then placed inside pressure vessel 201. Pressure vessel 201 is filled with infiltration epoxy either before or after component 101 is inserted. Lid 203 seals pressure vessel 201, which is then pressurized internally by pumping in additional epoxy through fill port 205. Fill port 205 is located on FIG. 2 on lid 203 at the top of the pressure vessel 201, although such location is exemplary only. After a predetermined epoxy infiltration period, the pressure inside pressure vessel 201 may be relieved, component 101 may be removed and the epoxy infiltrated into PTFE preform 105 is then allowed to cure. As with the first and second embodiments described with reference to FIG. 1, post-curing operations such as machining, sanding or grinding can then be used to obtain desired final dimensional and/or finish requirements.

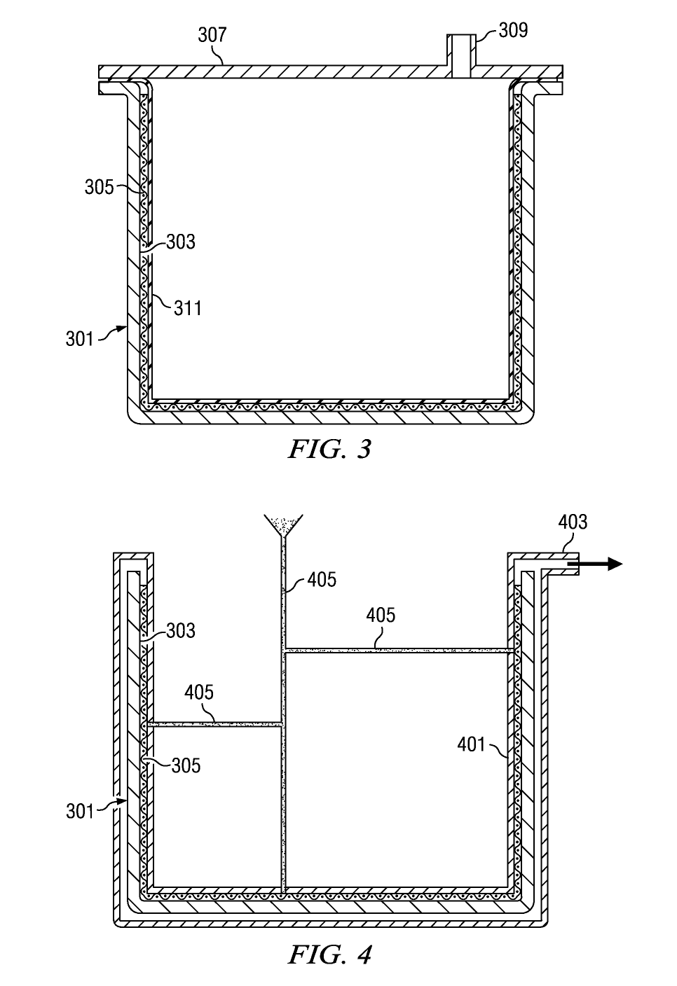

FIG. 3 illustrates a fourth embodiment of epoxy-based wear coatings consistent with the scope of this disclosure. In FIG. 3, component 301 is a different-shaped article of manufacture from component 101 illustrated on FIGS. 1 and 2, in which an internal metallic substrate surface 303 of component 301 is presented for coating. PTFE preform 305 on FIG. 3 is prepared consistent with PTFE preform 105 on FIGS. 1 and 2. Similar to embodiments described with reference to FIG. 2, PTFE preform 305 is conformed to metallic substrate surface 303 on FIG. 3 and attached using the same epoxy that will be used to infiltrate PTFE preform 305. Alternatively, other conventional types of temporary attachment may be used to attach PTFE preform 305 to metallic substrate surface 303, such as mechanical attachments or other adhesives that are complimentary to and non-harmful to the epoxy being used to infiltrate the PTFE preform 305. Sealing plate 307 is then placed over component 301 such that a water and/or air-tight seal is created between sealing plate 307 and component 301. Sealing plate 307 provides fill port 309. Component 301 is then filled with epoxy through fill port 309, and is further pressurized internally by pumping in additional epoxy through fill port 309. Epoxy infiltrates PTFE preform 303 under pressure. After a predetermined epoxy infiltration period, the pressure inside component 301 may be relieved, and excess epoxy is drained out of component 301. The epoxy infiltrated into PTFE preform 305 is then allowed to cure. As with the previous embodiments described with reference to FIGS. 1 and 2, post-curing operations such as machining, sanding or grinding can then be used to obtain desired final dimensional and/or finish requirements.

A fifth embodiment is illustrated further on FIG. 3. In the fifth embodiment, PTFE preform 305 is saturated with epoxy prior to placement on metallic substrate surface 303, similar to treatment of PTFE preform 105 on FIG. 1. Natural capillary forces are relied upon to carry out the epoxy infiltration process during the saturation step. Once positioned and conformed on metallic substrate surface 303, a thin layer of plastic or rubber lining 311 is then applied over PTFE preform 305 in its uncured, infiltrated state. Sealing plate 307 is deployed as before to create a water and/or air-tight seal between sealing plate 307 and lining 311. Component 301 is then pressurized through fill port 309 with air or other gas such as nitrogen, argon, etc. After a pre-determined period, the pressure is relieved and sealing plate 307 removed. If desired, liner 311 can be removed before epoxy curing, or it can be left in place and allowed to become an integral part of the composite epoxy-based wear coating. The epoxy infiltrated into PTFE preform 305 is then allowed to cure. As with the previous embodiments described with reference to FIGS. 1 and 2, post-curing operations such as machining, sanding or grinding can then be used to obtain desired final dimensional and/or finish requirements.

FIG. 4 illustrates a sixth embodiment of epoxy-based wear coatings consistent with the scope of this disclosure. Embodiments described with referenced to FIG. 4 are similar to those described with reference to FIGS. 2 and 3, except that rather than exerting external pressure via epoxy or gas, epoxy infiltration is encouraged via vacuum impregnation, as is conventional in in many industrial operations in the manufacture of articles such as boat hulls and automotive bodies. With reference to FIG. 4, PTFE preform 305 is conformed to metallic substrate surface 303 on component 301 and is attached using the same epoxy that will be used to infiltrate PTFE preform 305. Alternatively, other conventional types of temporary attachment may be used to attach PTFE preform 305 to metallic substrate surface 303, such as mechanical attachments or other adhesives that are complimentary to and non-harmful to the epoxy being used to infiltrate the PTFE preform 305. Component 301 is then placed inside vacuum bag 401. A conventional vacuum pump (not illustrated) pulls a vacuum on vacuum bag 401 via vacuum port 403. Once a predetermined vacuum level is achieved, epoxy infiltration tubes 405 are opened and epoxy is allowed to flow into vacuum bag 401 and over PTFE preform 305. Atmospheric pressure forces the epoxy to infiltrate into the porous PTFE preform 305, filling voids and bonding the coating system to surface 301. After curing of the epoxy, the vacuum may be released on vacuum bag 401. It will be further appreciated that in another variation on the sixth embodiment, PTFE preform 305 could be saturated with epoxy prior to placement on metallic substrate surface 303 (similar to embodiments described with reference to FIG. 1), and before the application of vacuum pressure. The introduction of additional epoxy through epoxy infiltration tubes 405 would then be optional.

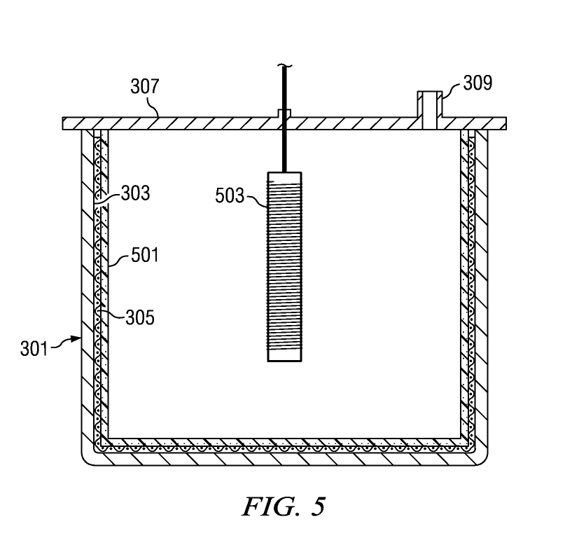

FIG. 5 illustrates a seventh embodiment of epoxy-based wear coatings consistent with the scope of this disclosure. In FIG. 5, and similar to embodiments described with reference to FIGS. 3 and 4, PTFE preform 305 is placed and conformed on an internal metallic substrate surface 303 of component 301 using a temporary adhesive that is complimentary and non-harmful to the epoxy that will be used to infiltrate PTFE preform 305. On FIG. 5, however, a second PTFE preform 501 is placed and conformed on PTFE preform 305. Second PTFE preform 501 is preferably a fibrillated PTFE preform admixed with solid epoxy resin and without hard particle admixtures, and may be manufactured generally according to the disclosures of Breton and Aberg in U.S. Pat. Nos. 3,864,124 and 4,624,860 (identified earlier in this disclosure), although the scope of this disclosure is not limited in this regard. In other embodiments, PTFE preform 501 may be substituted for a layer of solid polymer resin applied using conventional techniques other than with PTFE preforms. Referring further to FIG. 5, after second PTFE preform 501 is placed and conformed, electric heater 503 is positioned inside component 301, and sealing plate 307 is placed over component 301 such that a water and/or air-tight seal is created between sealing plate 307 and component 301. Sealing plate 307 provides fill port 309 and through connections to electric heater 503. Electric heater 503 is energized to a temperature at which the epoxy resin in second PTFE preform 501 begins to soften. At that point, internal pressure may be applied through fill port 309 with air or other gas such as nitrogen, argon, etc. The internal pressure forces the melting epoxy resin to infiltrate into the pore structure of PTFE preform 305. After a pre-determined period, the pressure is relieved and the heater is de-energized. Seal plate 307 may then be removed. The epoxy infiltrated into PTFE preform 305 is allowed to cure. As with previous embodiments described with reference to earlier Figures, post-curing operations such as machining, sanding or grinding can then be used to obtain desired final dimensional and/or finish requirements.

In other embodiments, not illustrated, a metallic substrate surface of a component may be initially coated with a hard particle coating using fibrillated PTFE preforms that are heated to elevated temperatures sufficient to vaporize the PTFE. Such initial coatings are conventional, and may be applied, just for example, using techniques in which a brazed hard particle coating is deployed on a metallic substrate surface consistent with the disclosure of U.S. Pat. No. 3,743,556 to Breton et al. It will be understood that epoxy is not used in this initial coating phase. Once cooled, the hard particle coating contains voids that were previously occupied by PTFE fibrils. Epoxy may then be infiltrated into these voids using natural capillary action, or encouraged by pressure or vacuum, consistent with embodiments illustrated and described above.

While materials classified as epoxies are believed to offer the best combination of strength, hardness and chemical resistance, other types of materials such as urethanes and methacrylate may be substituted for epoxies in the disclosed embodiments.

Although the inventive material in this disclosure has been described in detail along with some of its technical advantages, it will be understood that various changes, substitutions and alternations may be made to the detailed embodiments without departing from the broader spirit and scope of such inventive material.

I claim:

1. A method for deploying an epoxy-based coating on a surface of an article, the method comprising the steps of:
(a) providing an article including a metallic surface to be coated, the metallic surface presenting itself as a substrate;
(b) preparing a self-sustaining, cloth-like, flexible, non-woven fibrillated PTFE preform with voids therein;
(c) conforming the preform to the metallic surface;
(d) infiltrating at least some of the voids with an epoxy in an uncured state; and
(e) curing the epoxy;
whereby an epoxy-based coating is formed on the metallic surface.

2. The method of claim 1, in which the PTFE preform in step (b) is a composite fibrillated PTFE preform comprising PTFE mixed with hard particles.

3. The method of claim 2, in which the hard particles are selected from the group consisting of (1) metal oxide particles and (2) metal carbide particles.

4. The method of claim 1, in which infiltration in step (d) is encouraged by at least one technique selected from the group consisting of:
(1) elevated epoxy pressure;
(2) elevated gas pressure; and
(3) vacuum pressure.

5. The method of claim 1, in which step (d) comprises the substeps of:
(d1) conforming a solid epoxy layer on the preform such that the preform separates the solid epoxy layer and the metallic surface;
(d2) softening the solid epoxy layer via temperature elevation; and
(d3) promoting infiltration of softened epoxy in substep (d2) into voids in the preform.

6. The method of claim 5, in which substep (d3) is accomplished using a technique selected from the group consisting of:
(1) elevated epoxy pressure;
(2) elevated gas pressure;
(3) vacuum pressure; and
(4) natural capillary action.

7. The method of claim 5, in which the solid epoxy layer in substep (d1) comprises a fibrillated PTFE preform mixed with solid epoxy particles.

8. The method of claim 1, in which infiltration in step (d) comprises saturation of the preform with epoxy prior to conforming the preform to the metallic surface in step (c).

9. An article of manufacture having an epoxy-based coating, the epoxy coating deployed onto the article of manufacture according to the method of claim 1.

10. An article of manufacture having an epoxy-based coating, the epoxy coating deployed onto the article of manufacture according to the method of claim 2.
